(19) United States
(12) Patent Application Publication
(10) Pub. No.: US 2026/0153643 A1
(43) Pub. Date: Jun. 4, 2026

(54) MULTI-TUBULAR AZIMUTHAL INSPECTION TOOL

(71) Applicant: Halliburton Energy Services, Inc., Houston, TX (US)

(72) Inventors: Huiwen Sheng, Singapore (SG); Ahmed Fouda, Houston, TX (US); Joao Vicente Goncalves Rocha, Rio de Janeiro (BR); Diogo Luciano Figueiredo, Rio de Janeiro (BR); Leonardo Kessler Slongo, Rio de Janeiro (BR); Alexandre Henrique Brescovitt, Rio de Janeiro (BR); Leandro Becker Kehler, Rio de Janeiro (BR); Andre Franco Vieira Alves Beserra, Rio de Janeiro (BR); Diego Vidal Leite Ribeiro, Macae (BR); Sushovon Singha Roy, Houston, TX (US); Raphael Cesar Huber, Rio de Janeiro (BR); Cristiano Ribeiro de Vasconcellos, Rio de Janeiro (BR)

(73) Assignee: Halliburton Energy Services, Inc., Houston, TX (US)

(21) Appl. No.: 19/406,849

(22) Filed: Dec. 2, 2025

Related U.S. Application Data
(60) Provisional application No. 63/727,772, filed on Dec. 4, 2024.

(51) Int. Cl. G01V 3/38; E21B 47/002; E21B 47/02; E21B 47/085; G01V 3/28

(52) U.S. Cl. CPC G01V 3/38; E21B 47/0025; E21B 47/02; E21B 47/085; G01V 3/28

(57) ABSTRACT

A method that may include disposing an electromagnetic (EM) logging tool in a wellbore. The EM logging tool may include one or more transmitters disposed on the EM logging tool and one or more receivers disposed on the EM logging tool. The method may further include transmitting an electromagnetic field from the transmitter into one or more tubulars to energize the one or more tubulars with the electromagnetic field thereby producing an eddy current that emanates from the one or more tubulars, measuring the eddy current in the one or more tubulars with the receiver on at least one channel to obtain a plurality of measurements, and forming an EM log from the plurality of measurements.

### CROSS REFERENCE TO RELATED APPLICATIONS

This application claims the priority of U.S. Provisional Patent Application No. 63/727,772, filed Dec. 4, 2024, which is incorporated by reference in its entirety.

### BACKGROUND

For oil and gas exploration and production, a network of wells, installations and other conduits may be established by connecting sections of metal pipe together. For example, a well installation may be completed, in part, by lowering multiple sections of metal pipe (e.g., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

Electromagnetic (EM) techniques are commonly used to monitor the condition of the pipes in oil/gas wellbore including various kinds of casing strings and tubing. One common EM technique utilizes eddy current (EC). In EC, when the transmitter coil emits the primary transient EM fields, eddy currents are induced in the casing. These eddy currents then produce secondary fields which are combined with the primary fields to induce voltages on the receiver coil. The acquired data may then be employed to perform evaluation of the multiple pipes.

Early detection of metal loss of well components, like production tubing or casing, is of great importance to oil and gas wells management. Currently, the remote field eddy current tools may detect anomalies on multiple nested tubulars. This type of tool, based on axial transmitters that generate omnidirectional magnetic fields sensed by axial receivers, has low vertical resolution, and it has no azimuthal discrimination. That means the estimated metal loss is an average value of annular section of the pipe within the tool vertical resolution range. Therefore, it may fail to detect tubular anomalies, such as cracks, pitting, holes, and any metal loss due to corrosion may result in expensive remedial actions and shut down of production wells. Additionally, identifying tubular azimuthal anomalies in outer pipes or anomalies found on out pipes behind inner anomalies may be difficult.

### BRIEF DESCRIPTION OF THE DRAWINGS

These drawings illustrate certain aspects of some examples of the present disclosure and should not be used to limit or define the disclosure.

FIG. 1 illustrates an example of an EM logging tool disposed in a wellbore;

FIG. 2 illustrates an example of arbitrary defects within multiple pipes;

FIG. 3A illustrates an example of an EM logging tool traversing a wellbore;

FIG. 3B illustrates another example of an EM logging tool traversing a wellbore;

FIG. 3C illustrates another example of an EM logging tool traversing a wellbore;

FIG. 3D illustrates another example of the EM logging tool traversing a wellbore;

FIG. 3E illustrates another example of the EM logging tool traversing a wellbore;

FIG. 4A illustrates EM logging tool with deep azimuthal sensitivity;

FIG. 4B illustrates a hybrid design of the EM logging tool comprising a transmitter and receiver, where the receiver may further comprise a Hall-effect sensor;

FIG. 4C illustrates a structural arrangement of the receiver in FIG. 4B in a hybrid design;

FIG. 4D illustrates a cross-sectional view of the receiver in FIG. 4B with Hall-effect sensors disposed within pipe string and/or casing string;

FIG. 4E illustrates an embodiment in which a crown of Hall-effect sensors may be implemented as a standalone assembly;

FIG. 4F illustrates the crown of Hall-effect sensors that comprises three-axis sensors;

FIG. 4G illustrates an embodiment of the crown of Hall-effect sensors with multiple single-axis sensors;

FIGS. 5A & 5B illustrate different examples of a Z coil transmitter;

FIGS. 6A-6D illustrate different examples of radial coils for transmitters and receivers;

FIGS. 7A & 7B illustrate different EM core lamination layer arrangements for axial coils (Z coils);

FIGS. 8A-8C illustrate a cross section of different types of radial magnetic elements;

FIG. 9 is a graph of a Multistatic Data Matrix;

FIG. 10A-10E are 2D graphs formed from MDMs like in FIG. 9 for all logging positions (depths and azimuths); and

FIGS. 11A & 11B are 2D graphs of measurements formed from imaginary part of transmitters impedance.

### DETAILED DESCRIPTION

This disclosure may generally relate to pipe inspection in subterranean wells and, more particularly, to methods and systems for estimating metal loss in multiple nested pipes. Electromagnetic (EM) sensing may provide continuous in-situ measurements of parameters related to the integrity of pipes in cased boreholes. As a result, EM sensing may be used in cased borehole monitoring applications. EM logging tools may be configured for multiple concentric pipes (e.g., for one or more) with the first pipe diameter varying (e.g., from about two inches to about seven inches or more).

EM logging tools may measure voltage induced by eddy currents to determine metal loss, location of collars, and use magnetic cores with one or more coils to detect defects in multiple concentric pipes. The EM logging tools may use pulse eddy current (time-domain) and may employ multiple (long, short, and transversal) coils to evaluate multiple types of defects in multiple concentric pipes. It should be noted that the techniques utilized in time-domain may be utilized in frequency-domain measurements. In examples, EM logging tools may operate on a conveyance. Additionally, EM logging tools may include an independent power supply, data acquisition system, computer board, power amplifier, communication interface board, and may store the acquired data on memory.

Monitoring the condition of the production and intermediate casing strings is crucial in oil and gas field operations. EM eddy current (EC) techniques have been successfully used in inspection of these components. EM EC techniques include two broad categories: frequency-domain EC techniques and time-domain EC techniques. In both techniques, one or more transmitters are excited with an excitation signal, and the signals from the pipes are received and recorded for interpretation. The magnitude of a received signal is typically inversely proportional to the amount of metal that is present in the inspection location. For example, less signal magnitude is typically an indication of more metal, and more signal magnitude is an indication of less metal or more metal. This relationship may allow for measurements of metal loss, which typically is due to an anomaly related to the pipe such as corrosion or buckling. Metal gain may indicate the presence of a collar.

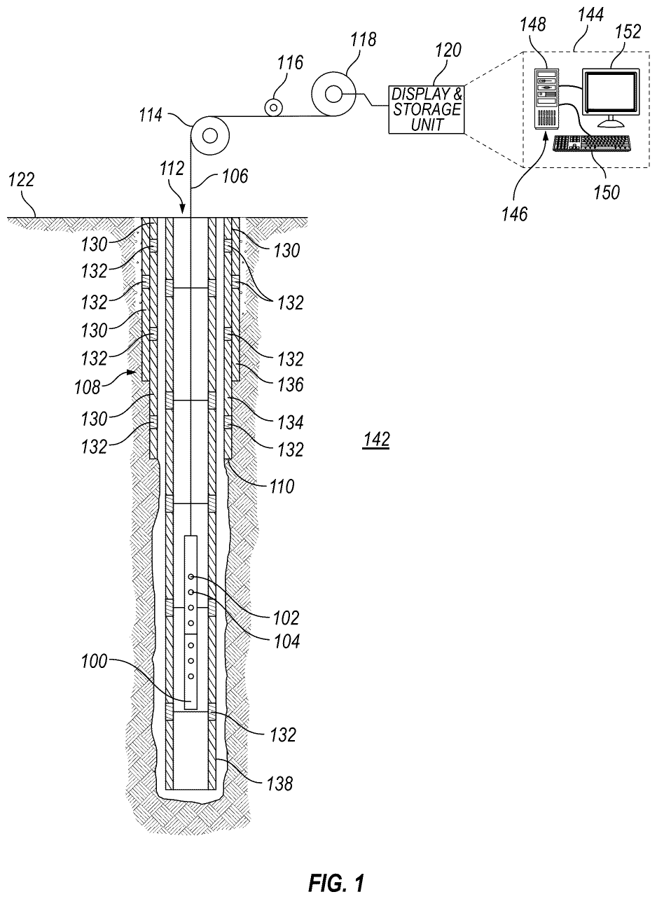

FIG. 1 illustrates an operating environment for an EM logging tool 100 as disclosed herein in accordance with some embodiments. In examples, EM logging tool 100 may comprise of Inconel, Titanium, or Aluminum. EM logging tool 100 may comprise a transmitter 102, a receiver 104, and/or and at least one bucking coil. In examples, transmitters 102 and receivers 104 may be coil antennas. It should be noted that receiver 104 may be referred to as an electromagnetic sensing element. The electromagnetic sensing element, receiver 104, may be a coil or a point source. A point source may by a Hall effect sensor. Furthermore, transmitter 102 and receiver 104 may be separated by a space between about 0.1 inches (0.254 cm) to about 200 inches (508 cm). In examples, EM logging tool 100 may be an induction tool that may utilize the electromagnetic sensing element to operate with continuous wave excitation of at least one frequency and/or current. Additionally, EM logging tool may further utilize electromagnetic sensing element to operate with a pulsed excitation current. This may be performed with any number of transmitters 102 and/or any number of receivers 104, which may be disposed on EM logging tool 100. In additional examples, transmitter 102 may function and/or operate as a receiver 104 or vice versa. EM logging tool 100 may be operatively coupled to a conveyance 106 (e.g., wireline, slickline, coiled tubing, pipe, downhole tractor, and/or the like) which may provide mechanical suspension, as well as electrical connectivity, for EM logging tool 100. Conveyance 106 and EM logging tool 100 may extend within casing string 108 to a desired depth within the wellbore 110. Conveyance 106, which may include one or more electrical conductors, may exit wellhead 112, may pass around pulley 114, may engage odometer 116, and may be reeled onto winch 118, which may be employed to raise and lower the tool assembly in wellbore 110.

Signals recorded by EM logging tool 100 may be stored on memory and then processed by display and storage unit 120 after recovery of EM logging tool 100 from wellbore 110. Alternatively, signals recorded by EM logging tool 100 may be conducted to display and storage unit 120 by way of conveyance 106. Display and storage unit 120 may process the signals, and the information contained therein may be displayed for an operator to observe and stored for future processing and reference. It should be noted that an operator may include an individual, group of individuals, or organization, such as a service company. Alternatively, signals may be processed downhole prior to receipt by display and storage unit 120 or both downhole and at surface 122, for example, by display and storage unit 120. Display and storage unit 120 may also contain an apparatus for supplying control signals and power to EM logging tool 100 in casing string 108.

A typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. Such as, a first casing 134 and a second casing 136. It should be noted that there may be any number of casing layers.

FIG. 1 also illustrates a typical pipe string 138, which may be positioned inside of casing string 108 extending part of the distance down wellbore 110. Pipe string 138 may be production tubing, tubing string, casing string, or other pipe disposed within casing string 108. Pipe string 138 may comprise concentric pipes. It should be noted that concentric pipes may be connected by collars 132. EM logging tool 100 may be dimensioned so that it may be lowered into the wellbore 110 through pipe string 138, thus avoiding the difficulty and expense associated with pulling pipe string 138 out of wellbore 110.

EM logging tool 100 may include a digital telemetry system which may further include one or more electrical circuits, not illustrated, to supply power to EM logging tool 100 and to transfer data between display and storage unit 120 and EM logging tool 100. The digital telemetry system may further comprise a navigation package that comprises a gyroscope or a magnetometer. A DC voltage may be provided to EM logging tool 100 by a power supply located above ground level, and data may be coupled to the DC power conductor by a baseband current pulse system. Alternatively, EM logging tool 100 may be powered by batteries located within EM logging tool 100 and data provided by EM logging tool 100 may be stored within EM logging tool 100, rather than transmitted to the surface to display and storage unit 120 during logging operations. The data may include signals and measurements related to corrosion detection.

During operations, transmitter 102 may broadcast electromagnetic fields into subterranean formation 142. It should be noted that broadcasting electromagnetic fields may also be referred to as transmitting electromagnetic fields. The electromagnetic fields transmitted from transmitter 102 may be referred to as a primary electromagnetic field. The primary electromagnetic fields may produce Eddy currents in casing string 108 and pipe string 138. These Eddy currents, in turn, produce secondary electromagnetic fields that may be sensed and/or measured by receivers 104. Characterization of casing string 108 and pipe string 138, including determination of pipe attributes, may be performed by measuring and processing primary and secondary electromagnetic fields. Pipe attributes may include, but are not limited to, pipe thickness, pipe conductivity, pipe ovality, and/or pipe permeability.

As illustrated, receivers 104 may be positioned on EM logging tool 100 at selected distances (e.g., axial spacing) away from transmitters 102. The axial spacing of receivers 104 from transmitters 102 may vary, for example, from about 0 inches (0 cm) to about 40 inches (101.6 cm) or more. It should be understood that the configuration of EM logging tool 100 shown in FIG. 1 is merely illustrative and other configurations of EM logging tool 100 may be used with the present techniques. A spacing of 0 inches (0 cm) may be achieved by collocating coils with different diameters. While FIG. 1 shows only a single array of receivers 104, there may be multiple sensor arrays where the distance between transmitter 102 and receivers 104 in each of the sensor arrays may vary. In addition, EM logging tool 100 may include more than one transmitter 102 and more or less than six receivers 104. In addition, transmitter 102 may be a coil implemented for transmission of magnetic field while also measuring EM fields, in some instances. Where multiple transmitters 102 are used, their operation may be multiplexed or time multiplexed. For example, a single transmitter 102 may broadcast, for example, a multi-frequency signal or a broadband signal. While not shown, EM logging tool 100 may include a transmitter 102 and receiver 104 that are in the form of coils or solenoids coaxially, orthogonally, and/or radially positioned within a downhole tubular (e.g., casing string 108) and separated along the tool axis. Alternatively, EM logging tool 100 may include a transmitter 102 and receiver 104 that are in the form of coils or solenoids coaxially, orthogonally, and/or radially positioned within a downhole tubular (e.g., casing string 108) and collocated along the tool axis.

Broadcasting of EM fields by transmitter 102 and the sensing and/or measuring of secondary electromagnetic fields by receivers 104 may be controlled by display and storage unit 120, which may include an information handling system 144. As illustrated, the information handling system 144 may be a component of or be referred to as the display and storage unit 120, or vice-versa. Alternatively, the information handling system 144 may be a component of EM logging tool 100. An information handling system 144 may include any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price.

Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc) and output device(s) 152 (e.g., monitor, printer, etc.). The input device(s) 150 and output device(s) 152 provide a user interface that enables an operator to interact with EM logging tool 100 and/or software executed by processing unit 146. For example, information handling system 144 may enable an operator to select analysis options, view collected log data, view analysis results, and/or perform other tasks.

EM logging tool 100 may use any suitable EM technique based on Eddy current (“EC”) for inspection of concentric pipes (e.g., casing string 108 and pipe string 138). EC techniques may be particularly suited for characterization of a multi-string arrangement in which concentric pipes are used. EC techniques may include, but are not limited to, frequency-domain EC techniques and time-domain EC techniques.

In frequency domain EC techniques, transmitter 102 of EM logging tool 100 may be fed by a continuous sinusoidal signal, producing primary magnetic fields that illuminate the concentric pipes (e.g., casing string 108 and pipe string 138). The primary electromagnetic fields produce Eddy currents in the concentric pipes. These Eddy currents, in turn, produce secondary electromagnetic fields that may be sensed, measured, and/or combined with the primary electromagnetic fields to induce voltages in the receivers 104. Characterization of the concentric pipes may be performed by measuring and processing these electromagnetic fields.

In time domain EC techniques, which may also be referred to as pulsed EC (“PEC”), transmitter 102 may be fed by a pulse. Transient primary electromagnetic fields may be produced due to the transition of the pulse from “off” to “on” state or from “on” to “off” state (more common). These transient electromagnetic fields produce EC in the concentric pipes (e.g., casing string 108 and pipe string 138). The EC, in turn, produces secondary electromagnetic fields that may be sensed and/or measured by receivers 104 placed at some distance on EM logging tool 100 from transmitter 102, as shown on FIG. 1. Alternatively, the secondary electromagnetic fields may be sensed and/or measured by a co-located receiver (not shown) or with transmitter 102 itself.

It should be understood that while casing string 108 is illustrated as a single casing string, there may be multiple layers of concentric pipes disposed in the section of wellbore 110 with casing string 108. EM log data may be obtained in two or more sections of wellbore 110 with multiple layers of concentric pipes. For example, EM logging tool 100 may make a first measurement of pipe string 138 comprising any suitable number of joints 130 connected by collars 132. Measurements may be taken in the time-domain and/or frequency range. EM logging tool 100 may make a second measurement in a casing string 108 of first casing 134, wherein first casing 134 comprises any suitable number of pipes connected by collars 132. Measurements may be taken in the time-domain and/or frequency domain. These measurements may be repeated any number of times for first casing 134, for second casing 136, and/or any additional layers of casing string 108. In this disclosure, as discussed further below, methods may be utilized to determine the location of any number of collars 132 in casing string 108 and/or pipe string 138. Determining the location of collars 132 in the frequency domain and/or time domain may allow for accurate processing of recorded data in determining properties of casing string 108 and/or pipe string 138 such as corrosion. As mentioned above, measurements may be taken in the frequency domain and/or the time domain.

In frequency domain EC, the frequency of the excitation may be adjusted so that multiple reflections in the wall of the pipe (e.g., casing string 108 or pipe string 138) are insignificant, and the spacing between transmitters 102 and/or receiver 104 is large enough that the contribution to the mutual impedance from the dominant (but evanescent) waveguide mode is small compared to the contribution to the mutual impedance from the branch cut component. In examples, a remote-field eddy current (RFEC) effect may be observed. In an RFEC regime, the mutual impedance between the coil of transmitter 102 and coil of one of the receivers 104 may be sensitive to the thickness of the pipe wall. To be more specific, the phase of the impedance varies as:

$$φ = 2 \sqrt{\frac{ωμσ}{2}} t \qquad ( 1 )$$

and the magnitude of the impedance shows the dependence:

$$exp [ - 2 ( \sqrt{\frac{ωμσ}{2}} ) t ] \qquad ( 2 )$$

where ω is the angular frequency of the excitation source, μ is the magnetic permeability of the pipe, σ is the electrical conductivity of the pipe, and t is the thickness of the pipe. By using the common definition of skin depth for the metals as:

$$δ = \sqrt{\frac{2}{ωμσ}} \qquad ( 3 )$$

The phase of the impedance varies as:

$$φ ≅ 2 \frac{t}{δ} \qquad ( 4 )$$

and the magnitude of the impedance shows the dependence:

$$exp [ \frac{- 2 t}{δ} ] \qquad ( 5 )$$

In RFEC, the estimated quantity may be the overall thickness of the metal. Thus, for multiple concentric pipes, the estimated parameter may be the overall or sum of the thickness of the pipes. The quasi-linear variation of the phase of mutual impedance with the overall metal thickness may be employed to perform fast estimation to estimate the overall thickness of multiple concentric pipes. For this purpose, for any given set of pipes dimensions, material properties, and tool configuration, such linear variation may be constructed quickly and may be used to estimate the overall thickness of concentric pipes. Information handling system 144 may enable an operator to select analysis options, view collected log data, view analysis results, and/or perform other tasks.

Monitoring the condition of pipe string 138 and casing string 108 may be performed on information handling system 144 in oil and gas field operations. Information handling system 144 may be utilized with Electromagnetic (EM) Eddy Current (EC) techniques to inspect pipe string 138 and casing string 108. EM EC techniques may include frequency-domain EC techniques and time-domain EC techniques. In time-domain and frequency-domain techniques, one or more transmitters 102 may be excited with an excitation signal which broadcast an electromagnetic field and receiver 104 may sense and/or measure the reflected excitation signal, a secondary electromagnetic field, for interpretation. The received signal is inversely proportional to the amount of metal that is around transmitter 102 and receiver 104. For example, less signal magnitude is typically an indication of more metal, and more signal magnitude is an indication of less metal. This relationship may be utilized to determine metal loss, which may be due to an abnormality related to the pipe such as corrosion or buckling.

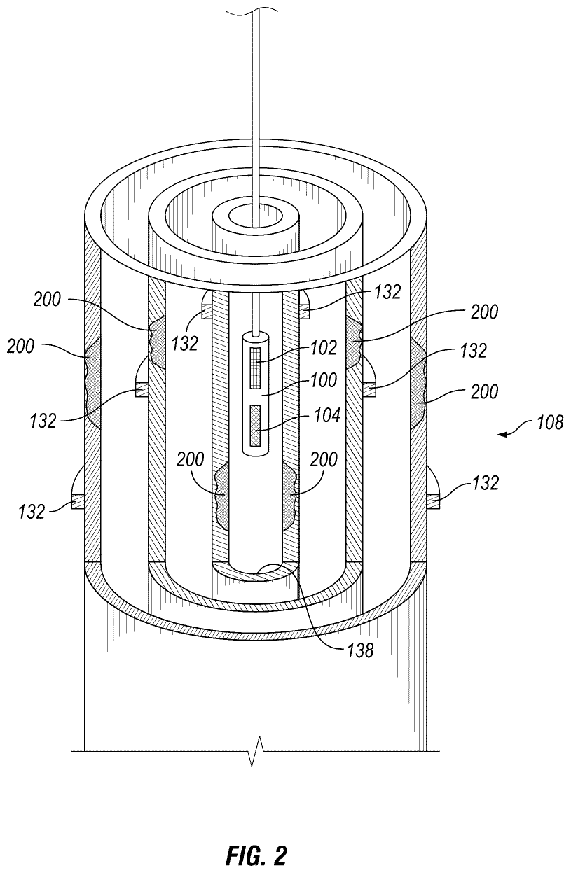

FIG. 2 shows EM logging tool 100 disposed in pipe string 138 which may be surrounded by a plurality of nested pipes (e.g., first casing 134 and second casing 136) and an illustration of anomalies 200 disposed within the plurality of nested pipes, in accordance with some embodiments. As EM logging tool 100 moves across pipe string 138 and casing string 108, one or more transmitters 102 may be excited, and a signal (receiver 104 induced voltage generated by eddy currents secondary magnetic field caused by transmitters 102 primary magnetic field) at one or more receivers 104, may be recorded.

Due to eddy current physics and electromagnetic attenuation, pipe string 138 and/or casing string 108 may generate an electrical signal that is in the opposite polarity to the incident signal and results in a reduction in the received signal. Typically, more metal volume translates to more lost signal. As a result, by inspecting the signal gains, it is possible to identify zones with metal loss (such as corrosion). In order to distinguish signals that originate from anomalies at different pipes of a multiple nested pipe configuration, multiple transmitter-receiver spacing, and frequencies may be utilized. For example, short-spaced transmitters 102 and receivers 104 may be sensitive to first casing 134, while longer spaced transmitters 102 and receivers 104 may be sensitive to second casing 136 and/or deeper (3rd, 4th, etc.) pipes. By analyzing the signal levels at these different channels with inversion methods, it is possible to relate a certain received signal to a certain metal loss or gain at each pipe. In addition to loss of metal, other pipe properties such as magnetic permeability and conductivity may also be estimated by inversion methods. It should be noted that inversion methods may include model-based inversion which may include forward modeling. However, there may be factors that complicate interpretation of losses. For example, deep pipe signals may be significantly lower than other signals. Double dip indications appear for long spaced transmitters 102 and receivers 104. Spatial spread of long spaced transmitter-receiver signals for a collar 132 may be long (up to 6 feet (1.8 meters)). Due to these complications, methods may need to be used to accurately inspect pipe features.

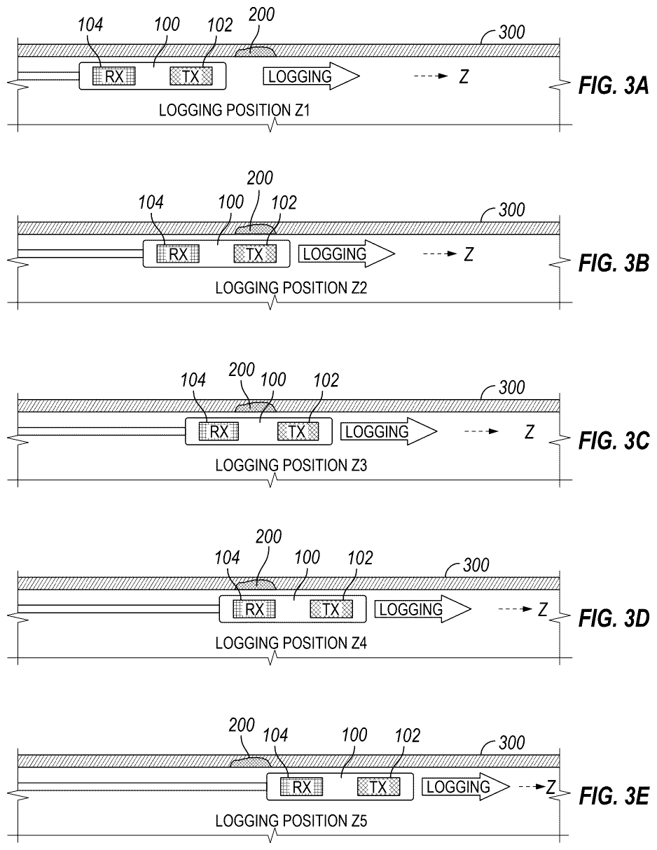

FIGS. 3A-3E illustrate an electromagnetic inspection and detection of anomalies 200 (e.g., defects) or collars 132 (e.g., Referring to FIG. 2), in accordance with some embodiments. As illustrated, EM logging tool 100 may be disposed in pipe string 138, by a conveyance, which may comprise any number of concentric pipes. As EM logging tool 100 traverses across pipe 300, one or more transmitters 102 may be excited, and a signal (mutual impedance between transmitter 102 and receiver 104) at one or more receivers 104, may be recorded. Due to eddy currents and electromagnetic attenuation, pipe 300 may generate an electrical signal that is in the opposite polarity to the incident signal and results in a reduction in a received signal. Thus, more metal volume translates to greater signal lost. As a result, by inspecting the signal gains, it may be possible to identify zones with metal loss (such as corrosion). Similarly, by inspecting the signal loss, it may be possible to identify metal gain such as due to presence of a casing collar 132 (e.g., Referring to FIG. 1) where two pipes meet with a threaded connection. In order to distinguish signals from different pipes in a multiple concentric pipe configuration, multiple transmitter-receiver spacing, and frequencies may be used. For example, short-spaced transmitters 102 and receivers 104 may be sensitive to pipe string 138, while long spaced transmitters 102 and receivers 104 may be sensitive to deeper pipes (e.g., first casing 124, second casing 136, etc.). By analyzing the signal levels at these different channels through a process of inversion, it may be possible to relate a certain received signal set to a certain set of metal loss or gain at each pipe. In examples, there may be factors that complicate the interpretation and/or identification of collars 132 and/or anomalies 200 (e.g., defects).

For example, due to eddy current physics and electromagnetic attenuation, pipes disposed in pipe string 138 (e.g., referring to FIG. 1 and FIG. 2) may generate an electrical signal that may be in the opposite polarity to the incident signal and results in a reduction in the received signal. Generally, as metal volume increases the signal loss may increase. As a result, by inspecting the signal gains, it may be possible to identify zones with metal loss (such as corrosion). In order to distinguish signals that originate from anomalies 200 (e.g., defects) at different pipes of a multiple nested pipe configuration, multiple transmitter-receiver spacing, and frequencies may be used. For example, short-spaced transmitters 102 and receivers 104 may be sensitive to first pipe string 138 (e.g., referring to FIG. 2), while long spaced transmitters 102 and receivers 104 may be sensitive to deeper (2^{nd}, 3^{rd}, etc.) pipes (e.g., first casing 134 and second casing 136).

Analyzing the signal levels at different channels with an inversion scheme, it may be possible to relate a certain received signal to a certain metal loss or gain at each pipe. In addition to loss of metal, other pipe properties such as magnetic permeability and electrical conductivity may also be estimated by inversion. There may be several factors that complicate interpretation of losses: (1) deep pipe signals may be significantly lower than other signals; (2) double dip indications appear for long spaced transmitters 102 and receivers 104; (3) spatial spread of long spaced transmitter-receiver signal for a collar 132 may be long (up to 6 feet); (4) to accurately estimate of individual pipe thickness, the material properties of the pipes (such as magnetic permeability and electrical conductivity) may need to be known with fair accuracy; (5) inversion may be a non-unique process, which means that multiple solutions to the same problem may be obtained and a solution which may be most physically reasonable may be chosen. Due to these complications, an advanced algorithm or workflow may be used to accurately inspect pipe features, for example when more than two pipes may be present in pipe string 138.

During logging operations as EM logging tool 100 traverses across pipe 300 (e.g., referring to FIG. 3), an EM log of the received signals may be produced and analyzed. The EM log may be calibrated prior to running inversion to account for the deviations between measurement and simulation (forward model). The deviations may arise from several factors, including the nonlinear behavior of the magnetic cores, magnetization of pipes, mandrel effect, and inaccurate well plans. Multiplicative coefficients and constant factors may be applied, either together or individually, to the measured EM log for this calibration. As discussed above, there may be any number of arrangements and spacing between transmitters 102 and/or receivers 104. Additionally, transmitters 102 and/or receivers 104 may be created and/or arranged to add deep azimuthal sensitivity.

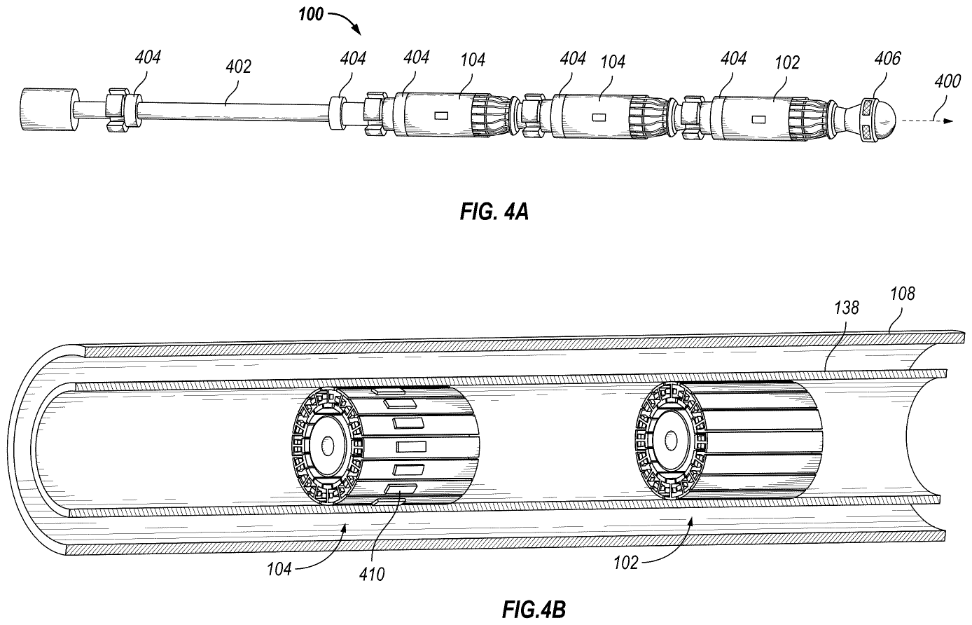

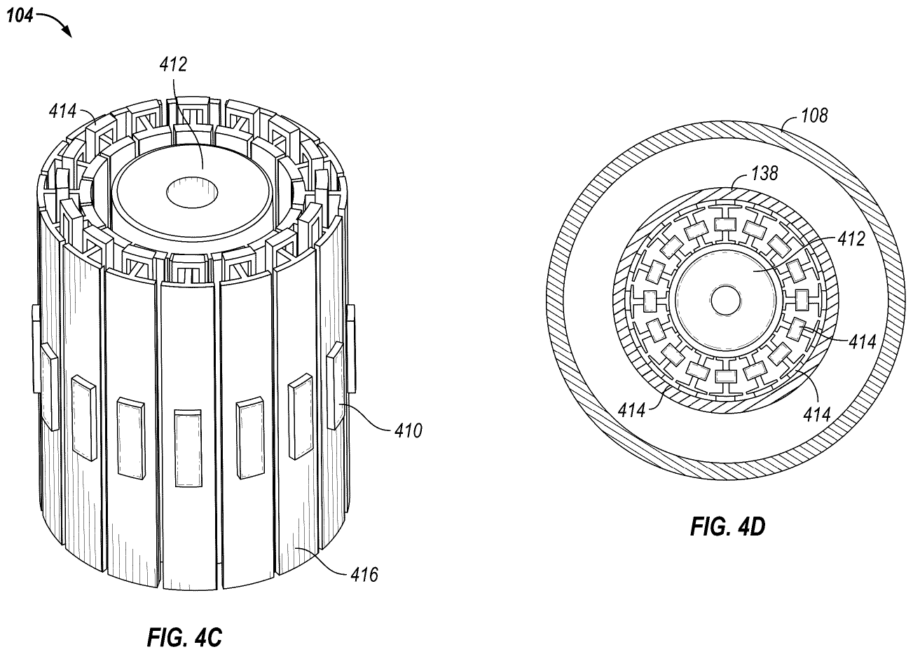

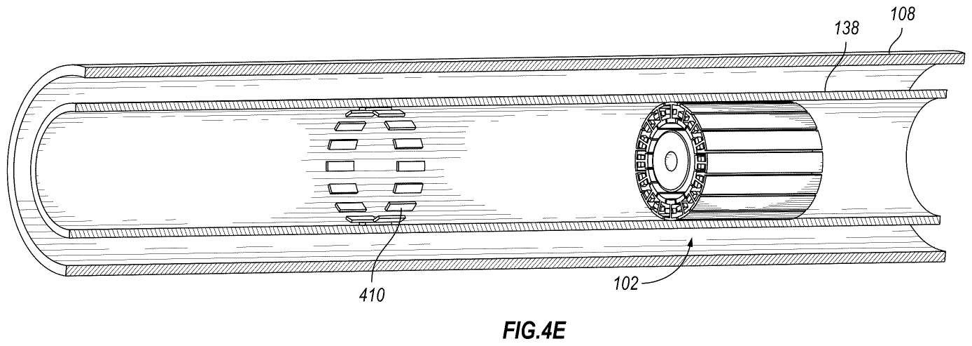

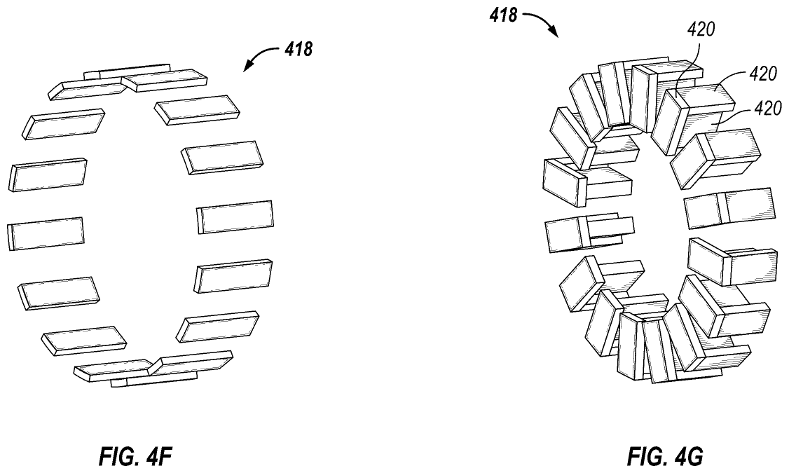

FIG. 4A illustrates EM logging tool 100 with deep azimuthal sensitivity, able to distinguish multi-tubular anomalies 200 (e.g., referring to FIG. 2) location and size (vertical and azimuth) using electromagnetic techniques. As described, EM logging tool 100 may work with a large set of different sensors and electronics embodiments, as well as measurements and post-processing numerical evaluation techniques. As illustrated, EM logging tool 100 may comprise of two group of radial coils (i.e., transmitters 102, receivers 104) distributed around axial axis 400, where one is responsible for transmitting magnetic flux (constant, sinusoidal, pulsed) to pipes 300 (e.g., referring to FIG. 3, and the other for receiving (or measuring) the magnetic flux from pipes 300, as described above. In examples, receivers 104 may be one or more coils, one or more magnets, or one or more electromagnets. Further, when one or more coils are utilized, the one or more coils may be wrapped around one or more ferromagnetic cores.

EM logging tool 100 may further comprise one or more isolators 404. Isolators 404 may be disposed between transmitters 102 and receiver 104 to suppress direct coupling between transmitter 102 and receivers 104. Isolators 404 may be configured to suppress interference between the array of electromagnetic sensing elements, discussed below. In examples, isolators 404 may comprise an electromagnetic shield backing or a tool mandrel with a magnetic permeability. Additionally, one or more bucking coils may be disposed along axial axis 400 between transmitters 102 and/or receivers 104 to dampen interference. Additionally, EM logging tool 100 may comprise a circumferential coverage mechanism 406. Circumferential coverage mechanism 406 may be an array of electromagnetic sensing elements deployed circumferentially within the logging tool, on one or more extendable arms, or is at least one rotating head. In examples, the at least one rotating head is interchangeable. In examples, at least one electromagnetic sensing element may have a polarization axis. The polarization axis is not parallel with the axis of EM logging tool 100. That is to say the polarization axis is non parallel, divergent, and/or convergent to the axis of EM logging tool 100. This may allow for circumferential measurements to be taken by the array of electromagnetic sensing elements. The circumferential measurements, which may be sent to information handling system 144, may be used to form a circumferential dataset. Information handling system 144 may perform depth aligning measurements from one or more measurements taken by the at least one electromagnetic sensing element. These depth aligning measurements may be applied to the circumferential measurements and help form the circumferential dataset. Information handling system 144 may utilize the circumferential data set to acquire at least one data matrix from the array of electromagnetic sensing elements and adjust excitation weights of the array of electromagnetic sensing elements to form one or more images, which may be displayed by information handling system 144.

The circumferential dataset may be utilized by information handling system 144 to estimate an eccentricity between one or more tubulars (e.g., pipe string 138 and/or casing string 108) and correct one or more measurements taken by the at least one electromagnetic sensing element using the estimate. Additionally, the one or more measurements from an array of electromagnetic sensing elements may be used by information handling system 144 in an omni-directional radial-one-dimensional or a two-dimensional inversions to estimate an average metal loss on at least one tubular (e.g., pipe string 138 and/or casing string 108). In examples, the average metal loss may be combined with an image representations of one or more anomalies, to form one or more images of a metal loss on one or more tubulars. Likewise, information handling system 144 may utilize the one or more measurements using a three-dimensional pixel-based inversion in which a 3D model of one or more tubulars (e.g., pipe string 138 and/or casing string 108) is constructed and subdivided into pixels and an electromagnetic material property of each pixel is estimated from the array of electromagnetic sensing elements using numerical optimization techniques.

When working with constant current, EM logging tool 100 measures any deviation on pipe string 138 (e.g., referring to FIGS. 1 & 2) by the magnetic flux leakage technique. However, when generating the magnetic field with sinusoidal or pulsed current, the EM logging tool 100 may evaluate the effect of eddy current induced in multiple pipes 300 with one or more receivers 104, one or more coils (or crowns of coils), and/or one or more Hall-effect sensors (or crowns of Hall-effect sensors). Transmitter 102 and receivers 104 grouped coils (or crowns) may be similar, and each transmitter coil has a respective receiver coil for the same azimuth. The multiple coils approach combined with multiple Hall-effect sensors adds the azimuthal defect distinguish capability to measurements performed by EM logging tool 100. Transmitters 102 and receivers 104 may provide both azimuthal and axial information of anomalies 200 (i.e., corrosion and defects) on pipe string 138 and/or pipes 300. As discussed further below, EM logging tool 100 may further comprise a long solenoid identified as a Z coil transmitter 402 with a plurality of crowns of radial coils (i.e., transmitters 102, receivers 104, and transceiver coils) and a plurality of crowns of Hall-effect sensors. FIG. 4B illustrates a hybrid design comprising transmitter 102, and receiver 104 where receiver 104 may further comprising a Hall-effect sensor 410. It should be noted that transmitter 102 and/or receiver 104 are disposed in two nested pipes. For example, the two nested pipes may be pipe string 138 and/or casing string 108. This may enable absolute magnetic field measurement and alternating current (AC) response for enhanced diagnostic capability. FIG. 4C illustrates a structural arrangement of receiver 104 in a hybrid design. As illustrated, receiver 104 may comprise a mandrel 412, sensing coil 414, magnetic core 416, and/or Hall-effect sensors 410. FIG. 4D illustrate a cross-sectional view of receiver 104 with Hall-effect sensors 410 disposed within pipe string 138 and/or casing string 108. FIG. 4E illustrates an embodiment in which a crown of Hall-effect sensors 410 may be implemented as a standalone assembly (apart from transmitter 102), without magnetic cores, which may utilize either single-axis sensors or three-axis sensors. FIG. 4F illustrates crown 418 that comprises three-axis sensors. FIG. 4G illustrates an embodiment of crown 418 when three-axis sensors are prohibitive, multiple single-axis sensors 420 may be utilized.

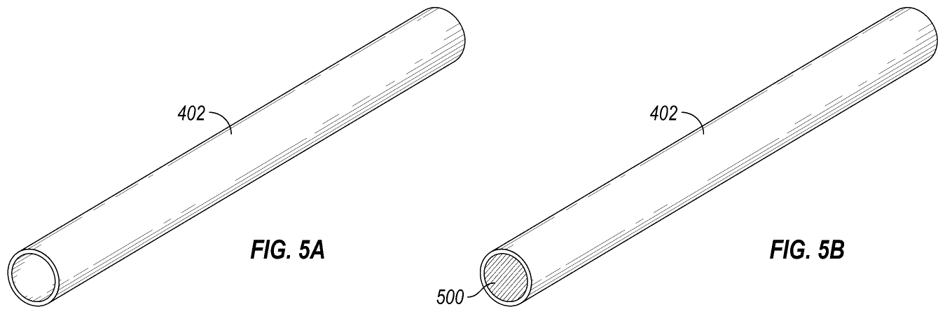

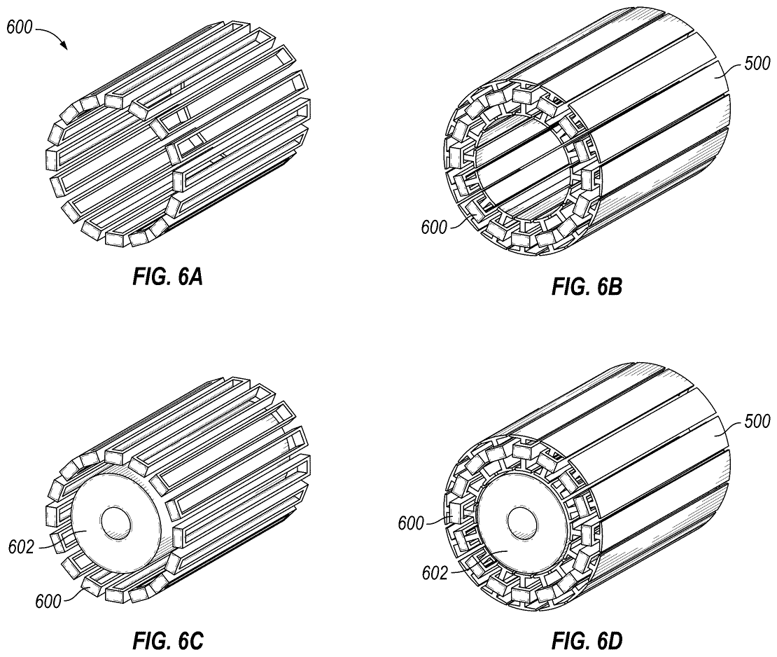

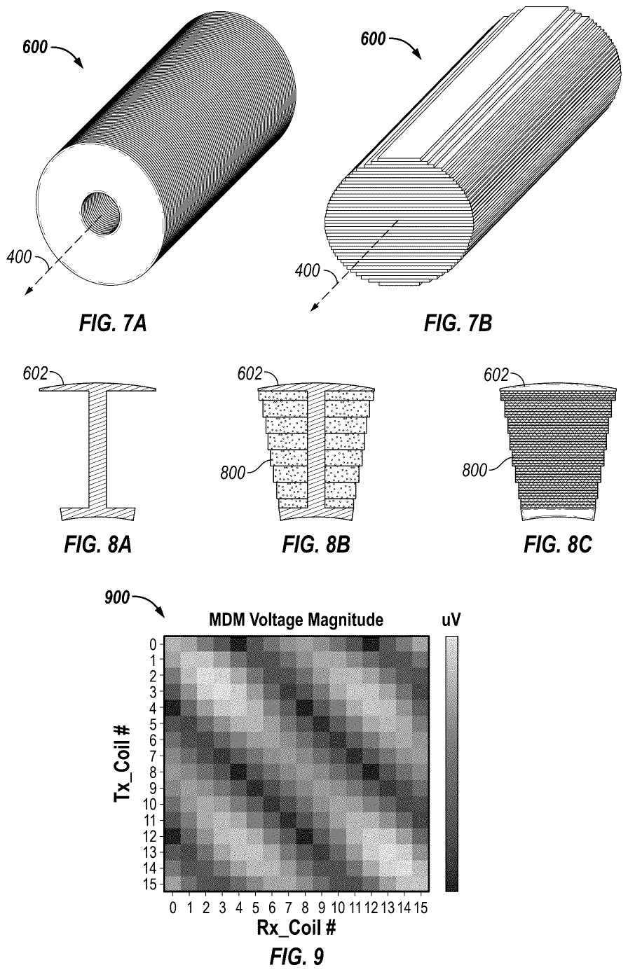

As noted above, EM logging tool 100 may operate using constant current (DC), alternate current (AC) or rectangular wave (pulse train). DC operation refers to the Magnetic Flux Leakage (MFL) technique, AC to Eddy Current technique in the frequency domain, and pulse train to Eddy Current technique in the time domain. Each crown of magnetic elements (i.e., transmitters 102, receivers 104) may comprise radial coils (coils whose axis is pointing in the radial direction-magnetic field generated from these coils may be polarized in the radial direction) and Hall-effect sensors spatially distributed azimuthally around axial axis 400, making an azimuthal transmitting and detection possible. Referring to FIGS. 5A and 5B, Z coil transmitter 402 may be mounted with or without magnetic mandrel 500. Likewise, as illustrated in FIGS. 6A-6D, crowns 600 of radial coils may be mounted with or without magnetic mandrel 500 and may comprise magnetic tooth cores 602. Magnetic mandrels 500 and magnetic tooth cores 602 may use Grain-Oriented Electrical Steel (GOES), with anisotropic relative permeability to facilitate the path of the magnetic field in a chosen direction, or Non-Grain-Oriented Electrical Steel (NGOES), with isotropic relative permeability. Moreover, to avoid the unwanted eddy currents from circulating in magnetic mandrels 500, magnetic mandrels 500 may be laminated accordingly. That is, crown 600 of radial coils mandrel laminated transversely, as illustrated in FIG. 7A, to axial axis 400 and Z coil transmitter 402 mandrel laminated parallelly, as illustrated in FIG. 7B, to axial axis. In both cases, the lamination layers may be stacked in a direction that is perpendicular to the eddy current generated by the respective transmitter 102 (e.g., referring to FIG. 4A) in order to cut the path for eddy current to flow in the mandrel and therefore reduce the loss.

FIGS. 8A-8C illustrate cross sections of different types of magnetic elements. For example, FIG. 8A illustrates a cross section of magnetic tooth core 602. FIG. 8B illustrates a cross-section windings 800 wound around magnetic tooth core 602 and FIG. 8C is a top-view of windings 800 wound around magnetic tooth core 602. The crown of radial coils angular resolution depends on the aperture angle formed by each magnetic element (i.e., magnetic tooth core 602 with windings 800)—which works as a window for the magnetic flux—and the number of magnetic elements on the crown. Additionally, transmitter signal depends on the number of turns and current magnitude (Ampère's law). On the other hand, receiver coils number of turns impacts the induced voltage (Faraday's law) for the same measure flux or flux variation. FIGS. 8A-8C illustrate a magnetic element example using optimized coils format (increased number of turns for a specific wire gauge).

EM measurements taken by EM logging tool 100 (e.g., referring to FIG. 1) may be performed by any number of techniques, where each technique may utilize a customized data processing approach. In the same way, each combination of transmitters 102 (Z coil transmitter 402 or crown of coils) with receiver 104 may also utilize a specific analysis. For example, transmitter 102 (e.g., referring to FIG. 4A) with 16 magnetic elements is excited with a sinusoidal current, which generates eddy current in pipe string 138 and/or pipes 300 (e.g., referring to FIGS. 2 and 3) under evaluation. Pipes eddy currents generate alternating magnetic fluxes, which are sensed by a receiver 104 (e.g., referring to FIG. 4A) with 16 magnetic elements. This specific case may be evaluated using a complex induced voltage matrix for all the combinations of magnetic elements (16×16), named as Multistatic Data Matrix (MDM), which is graph 900 shown in FIG. 9 for the magnitude component. The MDM may be further evaluated using several different mathematical approaches. The MDM may be acquired with the tool stationary at a given depth or while the tool is being continuously pulled.

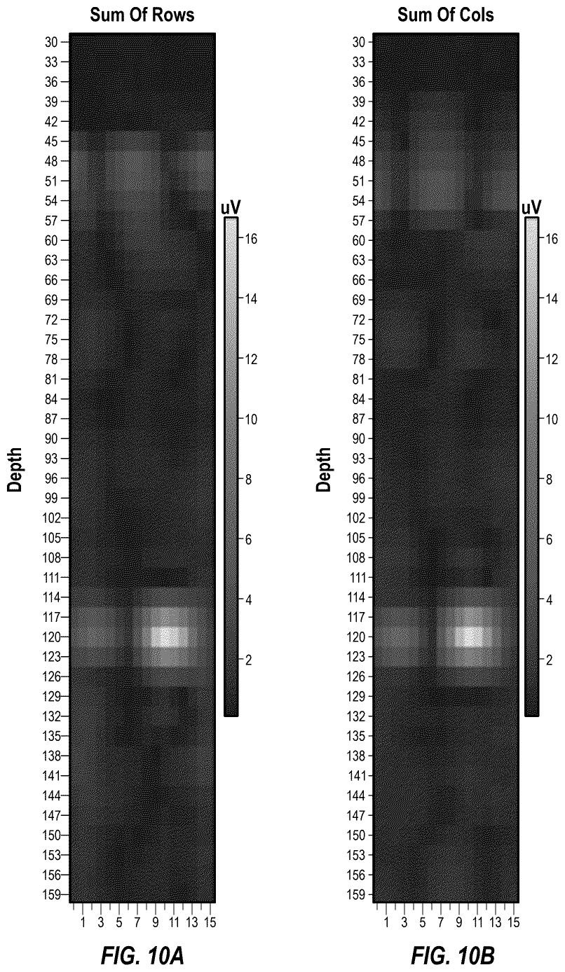

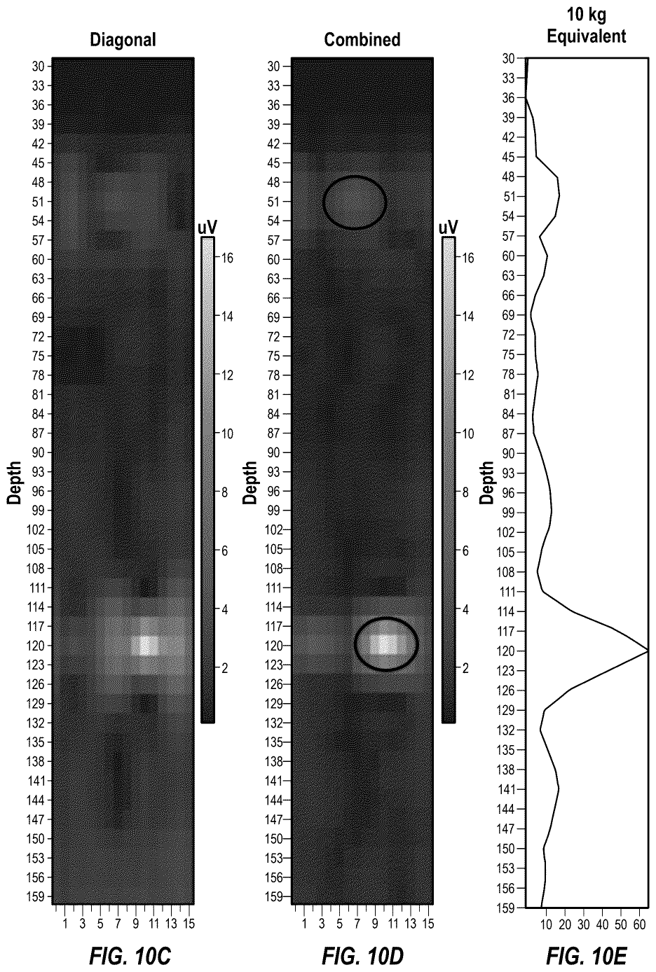

When inspecting multi-tubulars (i.e., pipe string 138, pipes 300) using this EM logging tool 100, each measured depth generates a single MDM. Therefore, to process the complete logging data, each MDM data may be flattened to a vector of 16 values, then combining all different depths in a single plot. For example, graph 900 of the MDM matrices may be flattened into multiple different graphs, as illustrated in FIG. 10A-10E. FIGS. 10A-10E are graphs illustrating four 2D logging graphs (FIGS. 10A-10D) and a one 1D logging graph (FIG. 10E). As illustrated, the graph in FIG. 10A is a sum of receiver coils (rows), FIG. 10B is a graph of the sum of transmitter coils (columns), FIG. 10C is a graph of the MDM diagonal, FIG. 10D is a graph of the combined metrics: sum of rows×sum of columns×MDM diagonal, an FIG. 10E is a graph of the 1D log equivalent (sum of all MDM elements−rows then columns). The 2D colormap results quality may be enhanced using advanced data processing techniques, such as software focusing. Furthermore, matrix decomposition operations such as singular value decomposition (SVD), eigenvalue decomposition (EVD), or principal component analysis (PCA) may be used to compress the three-dimensional MDM log into two-dimensional images indicative of pipe anomalies versus depth and azimuth.

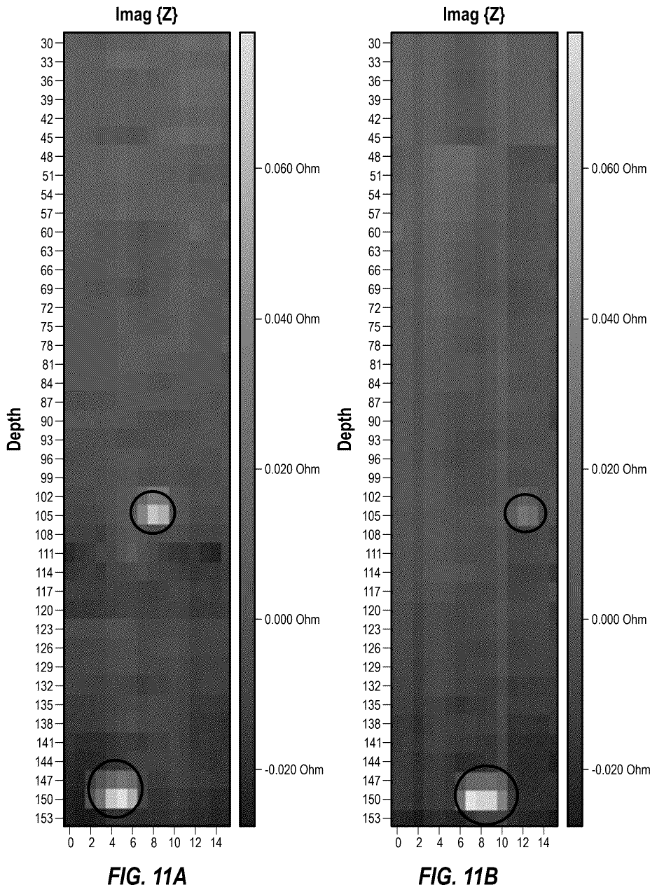

In other measurement techniques, for example, measurement techniques for an AC current excitation mode, impedance from transmitter 102 may be calculated from the measured induced voltage. In this case, a complex impedance vector of 16 elements is obtained for each depth. FIGS. 11A and 11B illustrate two logging graphs of measurements (Imaginary part) using 2D graphs. Alternatively, EM logging tool 100 may be mounted using the modular tool replacement concept. That is, each transmitter 102 previously mentioned may be mounted with each receiver 104, enabling EM logging tool 100 to be customizable to the given application based on the number of pipes 300, diameters of the pipes, thickness of the pipes, etc. Some examples of modular operation can be seen in Table 1.

TABLE 1

| | Z- | | | Hall-effect | |
|---|---|---|---|---|---|
| | Trans- | Rx | Rx | Sensor | Tx |
| Measurement | mitter | Crown 1 | Crown 2 | Crown | Crown |
| Z-R short | Active | Rx | | Rx | |
| Z-R long | Active | | Rx | Rx | |
| R-R short | | | Rx | Rx | Active Tx |
| R-R long | | Rx | | Rx | Active Tx |
| Azimuthal | | | | | Active Tx |
| Impedance | | | | | read |
| | | | | | impedance |

In other embodiments, referring back to FIG. 4A, Z coil transmitter 402 and transmitter 102 may be excited at different frequencies to enable simultaneous activation. Alternatively, CDMA can be used to code the signals differently. Still further, with continued reference to FIG. 4A, receivers 104 may be mounted using dedicated magnetic field sensors meters (such as, Hall effect sensors) instead of radial coils. This approach may enable a receiver 104 to use many more sensors (both in azimuth and depth), which may help to create a more elaborate MDM matrix, as illustrated in FIG. 9, and increase measurement answer product quality and accuracy.

Utilizing the configuration and formation of transmitters 102 and/or receiver 104 may allow for each transmitter 102 and/or receiver 104 to be azimuthally spaced around axial axis 400 to detect metal loss in multi-tubular wells. Spacing may allow for a versatility in operating modes from the point of view of hardware (different transmitters and receivers' combination, different spacings), excitation waveform and frequency (current excitation waveform), and measured data (magnetic flux, voltage or impedance). Spacings refers to different distances between the transmitter 102 and receiver 104. Short spacings and higher frequencies allow a higher resolution measurement of pipe string 138 (e.g., referring to FIG. 1). Long spacing and lower frequency allows the magnetic field to penetrate deeper resulting in a better visualization of casing string 108 (e.g., referring to FIG. 1).

For example, transmitter 102 (such as a Z coil transmitter) with receivers 104 that are disposed radially, may provide an increased signal to noise ratio SNR, due to the higher magnetic field generated by transmitter 102. However, this may only generate sixteen data point per depth. It does not allow the MDM generation. Mathematical operations performed with the MDM allow angular resolution improvements, which may be achieved with the combination with transmitters 102 disposed radially and receivers 104 disposed radially. The MFL techniques described above and below combined with the frequency domain may enable the possibility of identifying if anomalies 200 may be disposed the inner side of pipe string 138 or in the outer side. The time-domain technique is known to provide higher resolution for the inner pipes, but may present reduced sensitivity for outer pipes, specially when using small radial receiver coils. Additionally, Hall-effect sensor 410 may be utilized to measure the magnetic field direction, when assembling a 3-axis type of sensor. Hall-effect sensor 410 may also enable higher azimuthal resolution due to their reduced form factor compared with coils, which enables packing more sensors within the available space inside EM logging tool 100.

The plurality of these modes may enable high azimuthal resolution at multiple depths of investigation (DOIs) which may enable EM logging tool 100 to generate separate high-resolution images for pipe string 138 and/or pipes 300. Further methods of controlling transmitter 102 and/or receiver 104 during measurement operations may allow for greater sensitivity to anomalies 200 (e.g., referring to FIG. 2). Still further, information handling system 144 (e.g., referring to FIG. 1) may be configured to access a database of a 3D modeling for one or more anomalies 200 and select from the database the one or more anomalies 200 that best fits one or more measurements from an array of electromagnetic sensing elements (methods and systems for the array of electromagnetic sensing elements described above).

Early detection of metal loss of well components, like production tubing or casing, is of great importance to oil and gas wells management. Currently, the remote field eddy current tools may detect anomalies 200 on multiple nested tubulars (i.e., pipe string 138, pipes 300). However, measurements may have low vertical resolution, and no azimuthal discrimination. That means the estimated metal loss is an average value of annular section of pipe string 138 and/or pipes 300 within the tool vertical resolution range. Therefore, it may fail to detect tubular anomalies 200, such as, cracks, pitting, and holes. In this context, average metal loss may underestimate the severity of damage and that may result in expensive remedial actions and shut down of production wells.

Using transmitter and receiver designs discussed above, azimuthal discrimination may not be present, which may be possible with improved drive and control methods along with new hardware design. This may allow for EM logging tool 100 to have multiple operation modes that may be implemented with the control and drive system discussed below. Discussed below are EM azimuthal tool control, drive, and data acquisition system capable of driving EM logging tool 100 with different modes of operation.

Improvements over current technology are found in the EM logging tool with deep azimuthal sensitivity, able to distinguish multi-tubular defect location and size (vertical and azimuth) using electromagnetic techniques. The EM logging tool works with a large set of different sensors and electronics embodiments, as well as measurements and post-processing numerical evaluation techniques. As described above, EM logging tool may comprise of two group of radial coils distributed around the axial axis, where one is responsible for transmitting magnetic flux (constant, sinusoidal, pulsed) to the well pipes, and the other for receiving (or measuring) the magnetic flux from them. When working with constant current, the EM logging tool measures any deviation on the inner most pipe by the magnetic flux leakage technique. Additionally, when using sinusoidal or pulsed current, the EM logging tool evaluates the effect of eddy current generated in the multiple pipes. The transmitter and receiver grouped coils (or crowns) are very similar, and each TX coil has a respective RX coil for the same azimuth. The multiple coils approach adds the azimuthal defect distinguish capability for the EM logging tool, which may allow for detection of metal loss in multi-tubular wells. The versatility in the EM logging tool's operating modes from the point of view of hardware (different transmitters and receivers' combination, different spacings), excitation waveform and frequency (current excitation waveform), and measured data (magnetic flux, voltage or impedance). The plurality of these modes enables high azimuthal resolution at multiple depths of investigation (DOIs) which enables the tool to generate separate high-resolution images for each casing string.

The preceding description provides various examples of the systems and methods of use disclosed herein which may contain different method steps and alternative combinations of components.

Statement 1: A logging tool may comprise at least one electromagnetic sensing element with a polarization axis and a circumferential coverage mechanism.

Statement 2: The logging tool of statement 1, wherein the polarization axis is not parallel to an axis of the logging tool.

Statement 3: The logging tool of any previous statement, wherein the at least one electromagnetic sensing element is a coil, a magnet, or an electromagnet.

Statement 4: The logging tool of statement 3, wherein the coil is wrapped around one or more ferromagnetic cores.

Statement 5: The logging tool of any previous statements 1-3, wherein the at least one electromagnetic sensing element is a Hall effect sensor.

Statement 6: The logging tool of any previous statements 1-3 and 5, further comprising one or more transmitter coils, one or more receiver coils, and at least one bucking coil spaced apart along an axis of the logging tool.

Statement 7: The logging tool of any previous statements 1-3, 5, and 6, wherein the circumferential coverage mechanism comprises an array of electromagnetic sensing elements deployed circumferentially within the logging tool or on one or more extendable arms.

Statement 8: The logging tool of statement 7, further comprising an isolator, which is configured to suppress interference between the array of electromagnetic sensing elements.

Statement 9: The logging tool of statement 8, wherein the isolator comprises an electromagnetic shield backing or a tool mandrel with a magnetic permeability.

Statement 10: The logging tool of statements 7 or 8, wherein the array of electromagnetic sensing elements are configured to be excited sequentially or excited simultaneously.

Statement 11: The logging tool of any previous statements 1-3 or 5-7, wherein the circumferential coverage mechanism comprises at least one rotating head.

Statement 12: The logging tool of statement 11, wherein the at least one rotating head is interchangeable.

Statement 13: The logging tool of any previous statements 1-3, 5-7, or 11, further comprising a navigation package that comprises a gyroscope or a magnetometer.

Statement 14: The logging tool of any previous statements 1-3, 5-7, 11, or 13, wherein the at least one electromagnetic sensing element is configured to be excited with pulsed excitation current.

Statement 15: The logging tool of any previous statements 1-3, 5-7, 11, 13, or 14, wherein the at least one electromagnetic sensing element is configured to be excited with continuous wave excitation current.

Statement 16: The logging tool of any previous statements 1-3, 5-7, 11, or 13-15, wherein the at least one electromagnetic sensing element is configured to be excited with direct current (DC) excitation.

Statement 17: The logging tool of any previous statements 1-3, 5-7, 11, or 13-16, further comprises an information handling system in communication with the logging tool, wherein the information handling system may be configured to record a circumferential dataset from one or more measurements, or display the circumferential dataset as a two-dimensional image.

Statement 18: The logging tool of statement 17, wherein the information handling system is further configured to perform depth aligning measurements from one or more measurements taken by the at least one electromagnetic sensing element.

Statement 19: The logging tool of statement 17, wherein the information handling system is further configured to estimate an eccentricity between one or more tubulars and correct one or more measurements taken by the at least one electromagnetic sensing element using the estimate.

Statement 20: The logging tool of statement 17, wherein the information handling system is further configured to acquire at least one data matrix from an array of electromagnetic sensing elements disposed on the circumferential coverage mechanism and adjust excitation weights of the array of electromagnetic sensing elements to form one or more images.

Statement 21: The logging tool of statement 17, wherein the information handling system is further configured to process the one or more measurements from an array of electromagnetic sensing elements using an omni-directional radial-one-dimensional or a two-dimensional inversions to estimate an average metal loss on at least one tubular.

Statement 22: The logging tool of statement 21, wherein the information handling system is further configured to combine the average metal loss with an image representations of one or more anomalies, to form one or more images of a metal loss on one or more tubulars.

Statement 23: The logging tool of statement 17, wherein the information handling system is further configured to process one or more measurements taken by from an array of electromagnetic sensing elements using a three-dimensional pixel-based inversion in which a 3D model of one or more tubulars is constructed and subdivided into pixels and an electromagnetic material property of each pixel is estimated from the array of electromagnetic sensing elements using numerical optimization techniques.

Statement 24: The logging tool of statement 17, wherein the information handling system is further configured to access a database of a 3D modeling for one or more anomalies and select from the database the one or more anomalies that best fits one or more measurements from an array of electromagnetic sensing elements.

Statement 25: The logging tool of any previous statements 1-3, 5-7, 11, or 13-17, wherein the logging tool comprises of Inconel, Titanium, or Aluminum.

Statement 26: The logging tool of any previous statements 1-3, 5-7, 11, 13-17, or 25, further comprising one or more isolators disposed between a transmitter and a receiver.

It should be understood that, although individual examples may be discussed herein, the present disclosure covers all combinations of the disclosed examples, including, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A logging tool comprising:
at least one electromagnetic sensing element with a polarization axis; and
a circumferential coverage mechanism.

2. The logging tool of claim 1, wherein the polarization axis is not parallel to an axis of the logging tool.

3. The logging tool of claim 1, wherein the at least one electromagnetic sensing element is a coil, a magnet, or an electromagnet.

4. The logging tool of claim 3, wherein the coil is wrapped around one or more ferromagnetic cores.

5. The logging tool of claim 1, wherein the at least one electromagnetic sensing element is a Hall effect sensor.

6. The logging tool of claim 1, further comprising one or more transmitter coils, one or more receiver coils, and at least one bucking coil spaced apart along an axis of the logging tool.

7. The logging tool of claim 1, wherein the circumferential coverage mechanism comprises an array of electromagnetic sensing elements deployed circumferentially within the logging tool or on one or more extendable arms.

8. The logging tool of claim 7, further comprising an isolator, which is configured to suppress interference between the array of electromagnetic sensing elements.

9. The logging tool of claim 8, wherein the isolator comprises an electromagnetic shield backing or a tool mandrel with a magnetic permeability.

10. The logging tool of claim 7, wherein the array of electromagnetic sensing elements are configured to be excited sequentially or excited simultaneously.

11. The logging tool of claim 1, wherein the circumferential coverage mechanism comprises at least one rotating head.

12. The logging tool of claim 11, wherein the at least one rotating head is interchangeable.

13. The logging tool of claim 1, further comprising a navigation package that comprises a gyroscope or a magnetometer.

14. The logging tool of claim 1, wherein the at least one electromagnetic sensing element is configured to be excited with pulsed excitation current.

15. The logging tool of claim 1, wherein the at least one electromagnetic sensing element is configured to be excited with continuous wave excitation current.

16. The logging tool of claim 1, wherein the at least one electromagnetic sensing element is configured to be excited with direct current (DC) excitation.

17. The logging tool of claim 1, further comprises an information handling system in communication with the logging tool, wherein the information handling system is configured to:
record a circumferential dataset from one or more measurements; and
display the circumferential dataset as a two-dimensional image.

18. The logging tool of claim 17, wherein the information handling system is further configured to perform depth aligning measurements from one or more measurements taken by the at least one electromagnetic sensing element.

19. The logging tool of claim 17, wherein the information handling system is further configured to estimate an eccentricity between one or more tubulars and correct one or more measurements taken by the at least one electromagnetic sensing element using the estimate.

20. The logging tool of claim 17, wherein the information handling system is further configured to acquire at least one data matrix from an array of electromagnetic sensing elements disposed on the circumferential coverage mechanism and adjust excitation weights of the array of electromagnetic sensing elements to form one or more images.

21. The logging tool of claim 17, wherein the information handling system is further configured to process the one or more measurements from an array of electromagnetic sensing elements using an omni-directional radial-one-dimensional or a two-dimensional inversions to estimate an average metal loss on at least one tubular.

22. The logging tool of claim 21, wherein the information handling system is further configured to combine the average metal loss with an image representations of one or more anomalies, to form one or more images of a metal loss on one or more tubulars.

23. The logging tool of claim 17, wherein the information handling system is further configured to process one or more measurements taken by from an array of electromagnetic sensing elements using a three-dimensional pixel-based inversion in which a 3D model of one or more tubulars is constructed and subdivided into pixels and an electromagnetic material property of each pixel is estimated from the array of electromagnetic sensing elements using numerical optimization techniques.

24. The logging tool of claim 17, wherein the information handling system is further configured to access a database of a 3D modeling for one or more anomalies and select from the database the one or more anomalies that best fits one or more measurements from an array of electromagnetic sensing elements.

25. The logging tool of claim 1, wherein the logging tool comprises of Inconel, Titanium, or Aluminum.

26. The logging tool of claim 1, further comprising one or more isolators disposed between a transmitter and a receiver.
